(19) United States
(12) Patent Application Publication
(10) Pub. No.: US 2003/0019899 A1
(43) Pub. Date: Jan. 30, 2003

(54) Paper towel and separation device of the paper

(75) Inventors: Chien-Jung Chen, Kaohsiung (TW); Ming-Chung Lin, Kaohsiung (TW)

Correspondence Address: Bacon & Thomas, 4th Floor, 625 Slaters Lane, Alexandria, VA, 22314, US

(73) Assignee: Yen Sun technology Corp., Kaohsiung Hsien (TW)

(21) Appl. No.: 10/045,006

(22) Filed: Jan. 15, 2002

(30) Foreign Application Priority Data
Jul. 4, 2001 (TW) 90116695
Jul. 31, 2001 (TW) 90116695A01

(51) Int. Cl. B65H 35/10; B26F 3/02

(52) U.S. Cl. 225/10; 225/106

(57) ABSTRACT

A separation device of a paper towel includes a housing provided with two roll sets each having at least two rolls that may be driven by a power member to rotate relative to each other at an equal speed, so that a continuous paper towel may pass between the rolls of the two roll sets and may be pulled downward. The paper towel is provided with sensing marks at a predetermined length, so that when the sensing mark of the paper towel passes through a detection member, the detection member may detect passage of the sensing mark of the paper towel, and may send a signal, so that a rotation speed difference is produced between the rolls of the two roll sets, and the paper towel passing between the rolls of the two roll sets may be torn off.

### BACKGROUND OF THE INVENTION

1. Field of the Invention

The present invention relates to a paper towel and a separation device of the paper towel, and more particularly to a separation device having a simpler construction, so that the paper towel may be separated easily.

2. Description of the Related Art

A conventional cutting structure of a paper towel in accordance with the prior art shown in FIG. 1 is disclosed in the applicant's Taiwanese Patent Publication No. 168262. The conventional cutting structure of a paper towel comprises two wall plates 90 between which a roll 91, a press plate 92, a power wheel 93, and a blade wheel 94 are mounted. The paper is passed between the downward pressed press plate 92 and the roll 91, and is pulled downward by the power wheel 93 and the roll 91. The power wheel 93 may drive the roll 91 and the blade wheel 94 simultaneously. When the blade wheel 94 is rotated, the blade 95 of the blade wheel 94 contacts the chopping board 06, thereby cutting the passing paper.

However, the blade 95 of the blade wheel 94 contacts the chopping board 06 frequently, so that the blade 95 of the blade wheel 94 is easily worn out during long-term utilization, and the cutting effect is greatly affected, thereby causing a large load in maintenance, and causing inconvenience to the user. In addition, the conventional cutting structure of a paper towel has a complicated construction.

### SUMMARY OF THE INVENTION

The primary objective of the present invention is to provide a separation device of a paper towel, wherein the separation device has a simpler construction, so that the separation device may be manufactured easily, and the paper towel may be separated easily.

Another objective of the present invention is to provide a separation device of a paper towel, wherein the separation device of a paper towel needs not to provide a cutting blade set, thereby simplifying the construction, and facilitating production and assembly. In addition, the separation device of a paper towel does not have the problem of wear of the cutting blade, thereby facilitating maintenance.

A further objective of the present invention is to provide a separation device of a paper towel, wherein the paper towel may be separated easily at a predetermined length.

In accordance with the present invention, there is provided a separation device of a paper towel including a housing provided with two roll sets each having at least two rolls that may be driven by a power member to rotate relative to each other at an equal speed, so that a continuous paper towel may pass between the rolls of the two roll sets and may be pulled downward. The paper towel is provided with sensing marks at a predetermined length, so that when the sensing mark of the paper towel passes through a detection member, the detection member may detect passage of the sensing mark of the paper towel, and may send a signal, so that a rotation speed difference is produced between the rolls of the two roll sets, and the paper towel passing between the rolls of the two roll sets may be torn off. In addition, the roll faces of the multiple rolls provided by one of the two roll sets may form a non-single line, and the easily detachable line of the paper towel is formed by holes of different lengths.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional separation device of a paper towel in accordance with the prior art;

FIG. 2 is an exploded perspective view of a separation device of a paper towel in accordance with a first embodiment of the present invention;

FIG. 3 is a side plan cross-sectional assembly view of the separation device of a paper towel as shown in FIG. 2;

FIG. 4 is a cross-sectional view of the separation device of a paper towel taken along line 4-4 as shown in FIG. 3;

FIG. 5 is a schematic operational view of the separation device of a paper towel as shown in FIG. 4;

FIG. 6 is an exploded perspective view of a separation device of a paper towel in accordance with a second embodiment of the present invention;

FIG. 7 is a side plan cross-sectional assembly view of the separation device of a paper towel as shown in FIG. 6;

FIG. 8 is a schematic operational view of the separation device of a paper towel as shown in FIG. 7;

FIG. 9 is an exploded perspective view of a separation device of a paper towel in accordance with a third embodiment of the present invention;

FIG. 10 is a top plan assembly view of the separation device of a paper towel as shown in FIG. 9;

FIG. 11 is a front plan operational view of the separation device of a paper towel as shown in FIG. 9;

FIG. 12 is a schematic operational view of the separation device of a paper towel as shown in FIG. 11;

FIG. 13 is a top plan view of a separation device of a paper towel in accordance with a fourth embodiment of the present invention;

FIG. 14 is a front plan view of a separation device of a paper towel in accordance with a fourth embodiment of the present invention;

FIG. 15 is a top plan view of a separation device of a paper towel in accordance with a fifth embodiment of the present invention; and

FIG. 16 is a front plan view of a separation device of a paper towel in accordance with a fifth embodiment of the present invention.

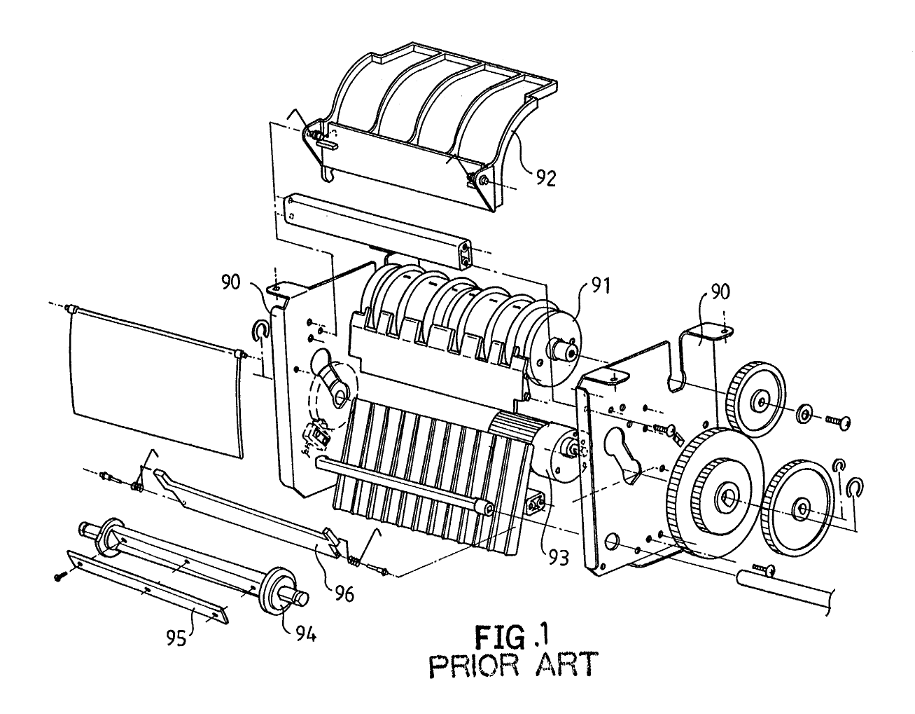

### DETAILED DESCRIPTION OF THE PREFERRED EMBODIMENTS

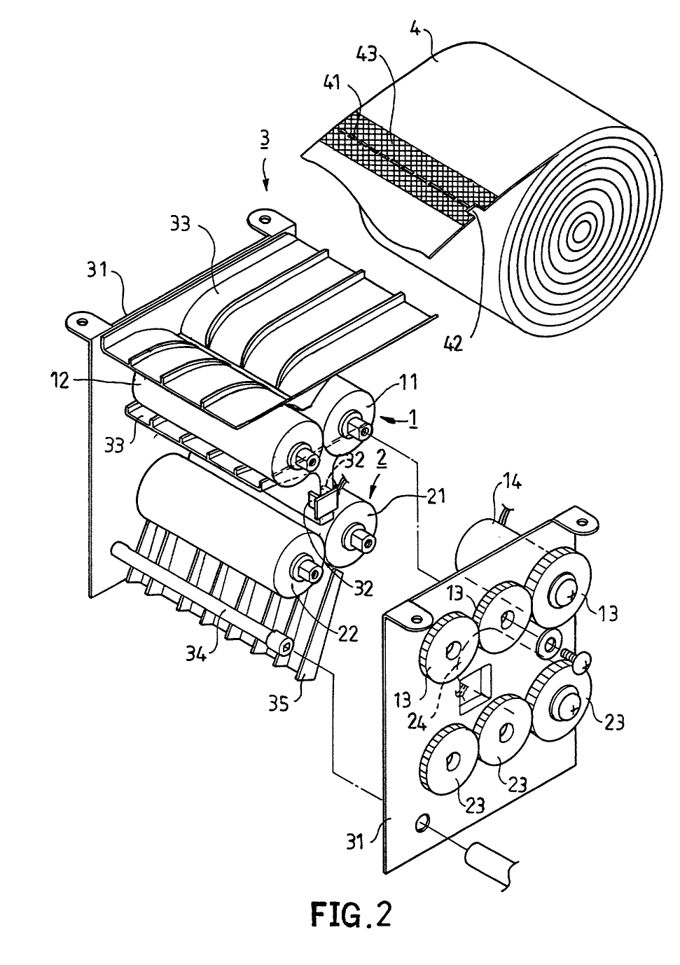

Referring to the drawings and initially to FIG. 2, a separation device of a paper towel in accordance with a first embodiment of the present invention is shown. The paper towel 4 used in the separation device is a continuous paper made of a material such as the natural fiber, artificial fiber, synthetic fiber and the like. The paper towel 4 may have a roll-shape or a foldable shape. The paper towel 4 is provided with multiple sensing marks 42 that may be in the form of a cutout, or may be formed on the paper towel 4 in a printing or bonding manner. The paper towel 4 may be provided with a easily detachable line 41, so that the paper towel 4 may be separated easily and smoothly. In addition, when the paper towel 4 is made of a material such as artificial fiber, synthetic fiber and the like, each of the two sides of the easily detachable line 41 is formed with a press portion 43 in a heat melted manner, thereby preventing from detachment of the fiber when the paper towel is cut.

The separation device comprises a housing 3, a first roll set 1, and a second roll set 2. The paper towel 4 may pass through the first roll set 1 and the second roll set 2 respectively.

The housing 3 may construct the housing wall of the entire separation device, and has at least two wall plates 31 between which the first roll set 1 and the second roll set 2 are pivotally mounted. The housing 3 is provided with a detection member 32 that may be a conventional light control detection member. When the sensing mark 42 of the paper towel 4 passes through the detection member 32, the detection member 32 may detect passage of the sensing mark 42 of the paper towel 4, and may send a signal, so that the paper towel 4 may enter the first roll set 1 and the second roll set 2 easily. A guide board 33 is mounted between the two wall plates 31, and is located above the first roll set 1 and the second roll set 2. The housing 3 may be provided with a conventional liquid spray tube 34 to wet the passing paper towel 4, and a guide plate 35 to guide the paper towel 4 outward.

The first roll set 1 consists of at least two rolls 11 and 12 each having two ends respectively pivoted on the wall plates 31. The roll faces of the two rolls 11 and 12 contact with each other or almost contact with each other. The two rolls 11 and 12 of the first roll set 1 may be rotated relative to each other by driving of drive members 13, such as gears, so that the paper towel 4 may pass between the two rolls 11 and 12, and may be pulled downward to the second roll set 2. The two rolls 11 and 12 of the first roll set 1 may be driven to rotate by a power member 14.

The second roll set 2 is located at the lower side or the rear side of the first roll set 1, and consists of at least two rolls 21 and 22 each having two ends respectively pivoted on the wall plates 31. The roll faces of the two rolls 21 and 22 contact with each other or almost contact with each other. The two rolls 21 and 22 of the second roll set 2 may be rotated relative to each other by driving of drive members 23, such as gears, so that the paper towel 4 may pass between the two rolls 21 and 22, and may be pulled downward. The two rolls 21 and 22 of the second roll set 2 may be driven to rotate by a power member 24.

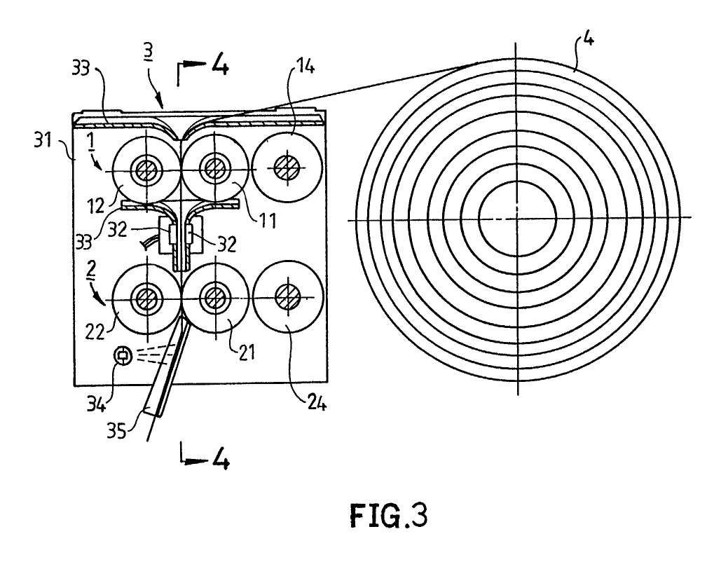

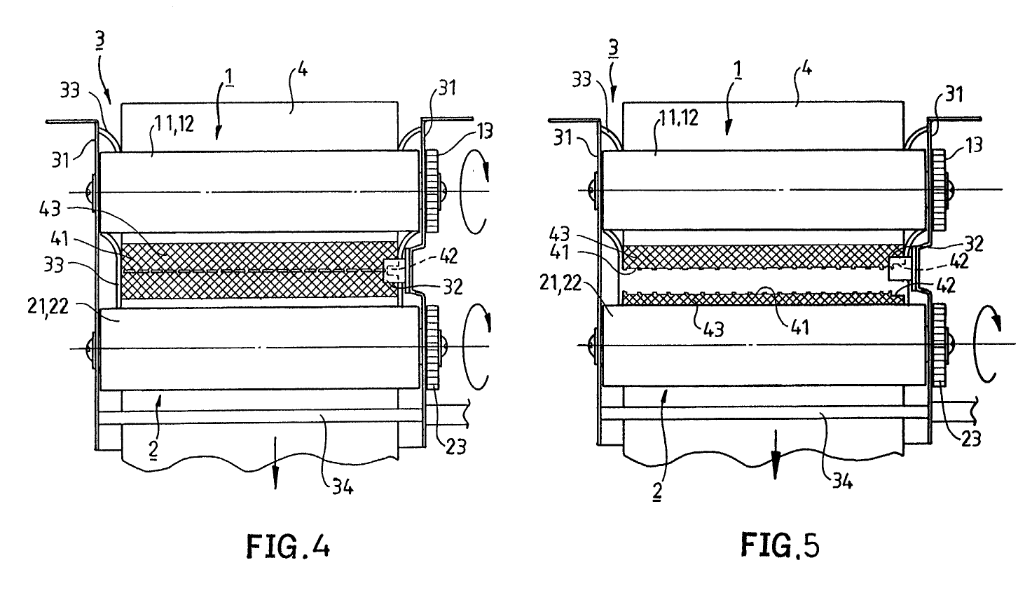

Referring to FIGS. 3 and 4, one end of the paper towel 4 is guided to pass through the two rolls 11 and 12 of the first roll set 1 and pass through the two rolls 21 and 22 of the second roll set 2, and may be pulled downward by rotation of the first roll set 1 and the second roll set 2. At this time, the first roll set 1 and the second roll set 2 may be rotated at an equal speed. When the sensing mark 42 of the paper towel 4 passes through the detection member 32, the detection member 32 may detect passage of the sensing mark 42 of the paper towel 4, and may send a signal, so that power member 14 of the first roll set 1 may stop operation or reduce its velocity. Thus, a pulled force is applied on the paper towel 4 between the first roll set 1 and the second roll set 2, so that the paper towel 4 may be separated from the easily detachable line 41 (see FIG. 5), and the separated paper towel 4 may be pulled downward by the two rolls 21 and 22 of the second roll set 2, to be guide outward by the guide plate 35.

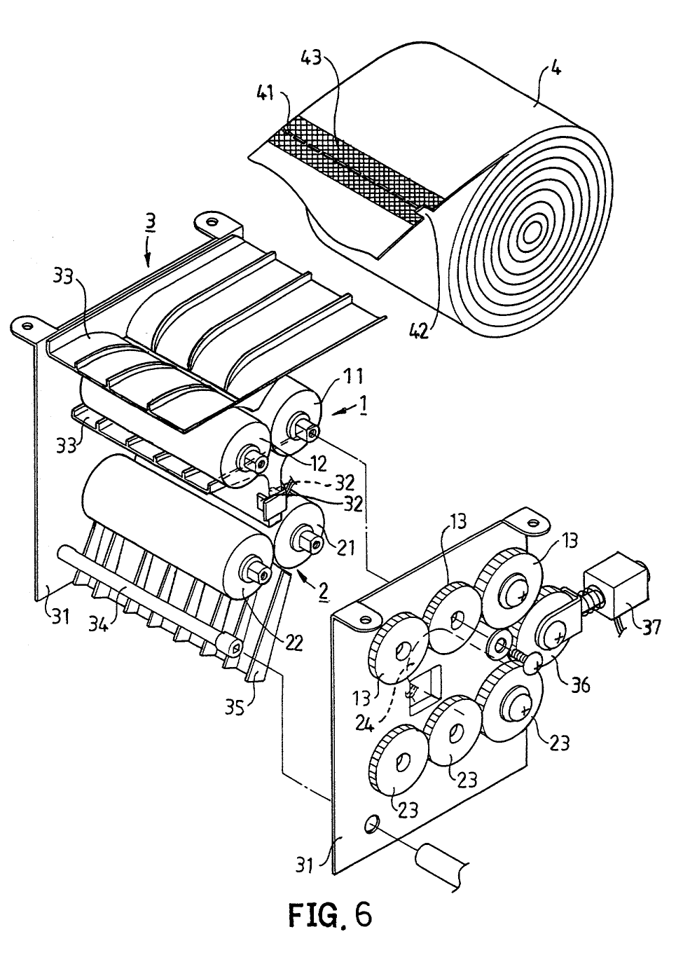

Referring to FIG. 6, a separation device of a paper towel in accordance with a second embodiment of the present invention is shown.

The housing 3 is provided with a clutch wheel 36 whose movement may be controlled by a controller 37 such as an electromagnetic valve. When the sensing mark 42 of the paper towel 4 passes through the detection member 32, the detection member 32 may detect passage of the sensing mark 42 of the paper towel 4, and may send a signal, so that the clutch wheel 36 may detach from the drive members 13 and 23 of the first roll set 1 and the second roll set 2, and may mesh with the drive members 13 and 23 of the first roll set 1 and the second roll set 2 again after a predetermined period of time.

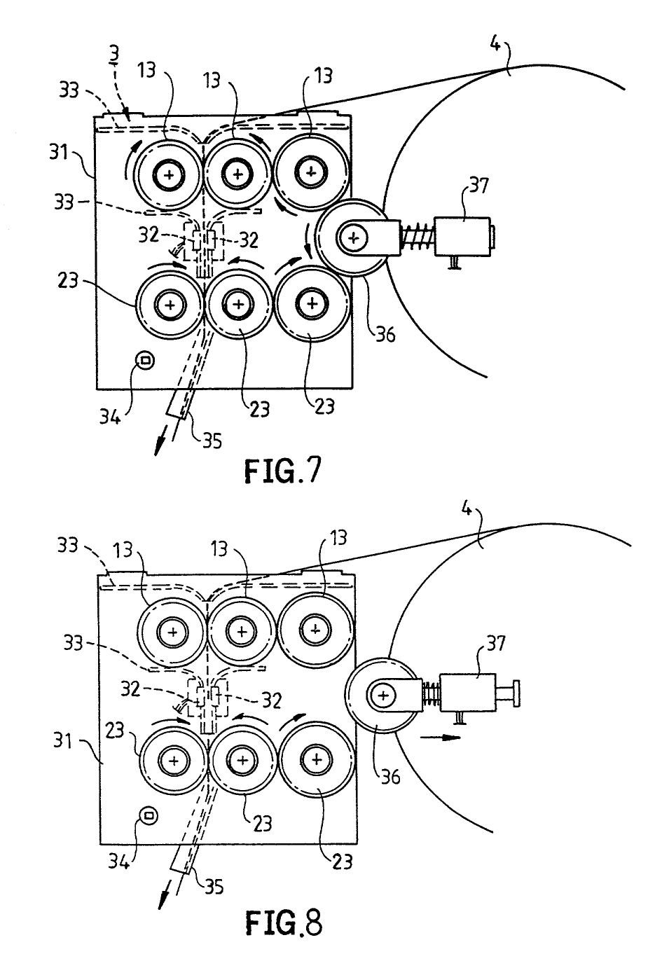

The first roll set 1 is not provided with a power member, while the second roll set 2 has a power member 24. Thus, when the clutch wheel 36 meshes with the drive members 13 and 23 of the first roll set 1 and the second roll set 2 as shown in FIG. 7, the rolls 11, 12, 21 and 22 of the first roll set 1 and the second roll set 2 may be rotated at an equal speed, and the paper towel 4 may be pulled downward. When the clutch wheel 36 detaches from the drive members 13 and 23 of the first roll set 1 or the second roll set 2 as shown in FIG. 8, the rolls 11 and 12 of the first roll set 1 may stop rotating. Thus, a pulled force is applied on the paper towel 4 between the first roll set 1 and the second roll set 2, so that the paper towel 4 may be separated from the easily detachable line 41.

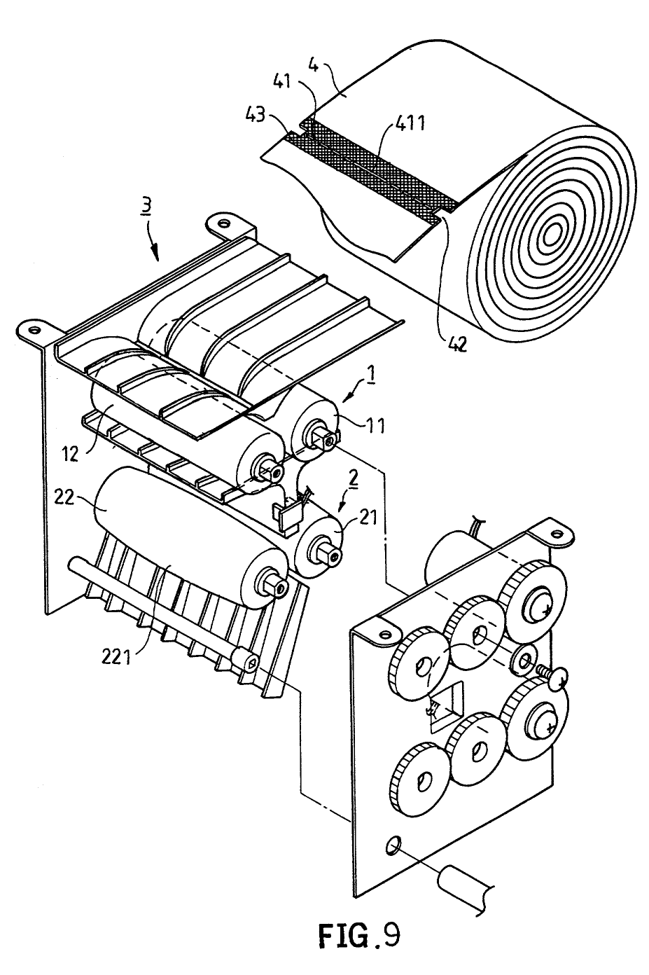

Referring to FIG. 9, a separation device of a paper towel in accordance with a third embodiment of the present invention is shown. The paper towel 4 used in the separation device is a continuous paper made of a material such as the natural fiber, artificial fiber, synthetic fiber and the like. The paper towel 4 may have a roll-shape or a foldable shape. The paper towel 4 is also provided with multiple sensing marks 42 that may be in the form of a cutout, or may be formed on the paper towel 4 in a printing or bonding manner. The paper towel 4 may be provided with a easily detachable line 41, so that the paper towel 4 may be separated easily and smoothly. In addition, when the paper towel 4 is made of a material such as artificial fiber, synthetic fiber and the like, each of the two sides of the easily detachable line 41 is formed with a press portion 43 in a heat melted manner, thereby preventing from detachment of the fiber when the paper towel is cut. Further, the easily detachable line 41 in the preferred embodiment may be constructed by holes of different lengths, including at least one elongated hole 411 which is larger than other holes 412 on the easily detachable line 41.

The first roll set 1 consists of at least two rolls 11 and 12. The roll faces of the two rolls 11 and 12 of the first roll set 1 contact with each other or almost contact with each other. The two rolls 11 and 12 of the first roll set 1 may be rotated relative to each other by driving of drive members, such as gears, so that the paper towel 4 may pass between the two rolls 11 and 12, and may be pulled downward to the second roll set 2.

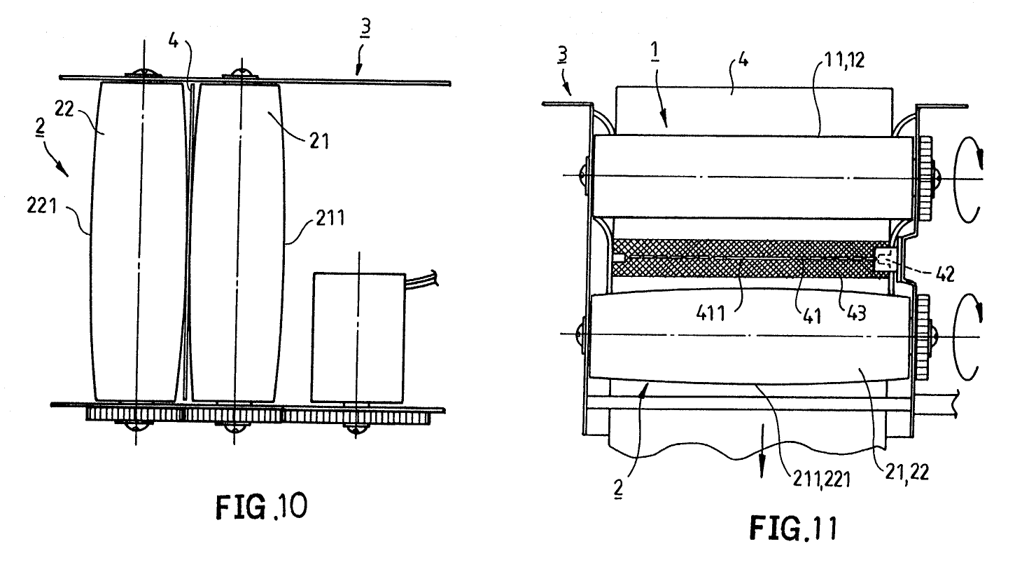

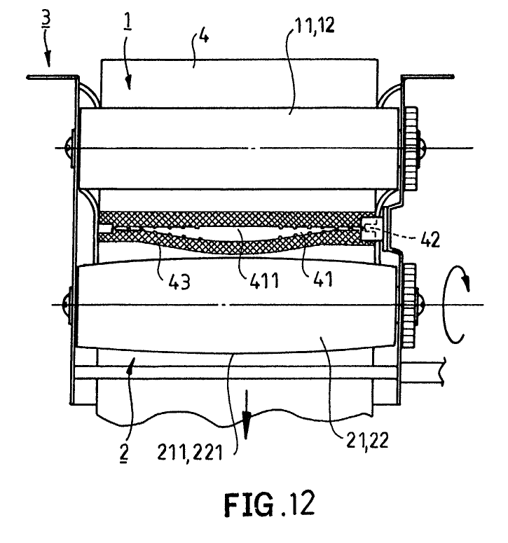

Referring to FIGS. 10 and 11, the second roll set 2 is located at the lower side or the rear side of the first roll set 1, and consists of two rolls 21 and 22. The two rolls 21 and 22 of the second roll set 2 may be rotated relative to each other by driving of drive members, such as gears, so that the paper towel 4 may pass between the two rolls 21 and 22, and may be pulled downward. Each of the roll faces of the two rolls 21 and 22 may form a non-single line. In the preferred embodiment, each of the roll faces of the two rolls 21 and 22 may form an arcuate face which has a mediate section having an arcuate convex portion 211 and 221. The arcuate convex portions 211 and 221 of the two rolls 21 and 22 contact with each other or almost contact with each other. Thus, the roll faces of the two rolls 21 and 22 only have smaller contact faces, and the contacting arcuate convex portions 211 and 221 of the two rolls 21 and 22 are aligned with the elongated hole 411 of the paper towel 4. Thus, when a rotation speed difference is produced between the first roll set 1 and the second roll set 2, the motor may provide a smaller drive torque to tear the paper towel 4 between the first roll set 1 and the second roll set 2 as shown in FIG. 12.

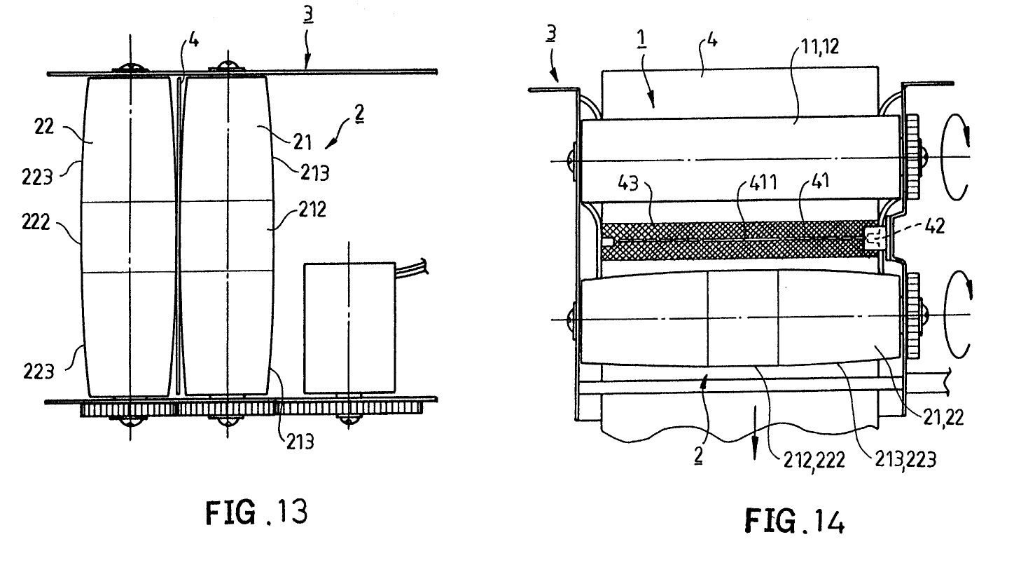

Referring to FIG. 13, the second roll set 2 of a separation device of a paper towel in accordance with a fourth embodiment of the present invention is shown. The second roll set 2 consists of two rolls 21 and 22. Each of the roll faces of the two rolls 21 and 22 may form a non-single line. In the preferred embodiment, each of the roll faces of the two rolls 21 and 22 has a mediate section formed with an equal-diameter portion 212 and 222 having a larger diameter. Each of the equal-diameter portions 212 and 222 has two sides each having an oblique shoulder portion 213 and 223. Thus, the roll faces of the two rolls 21 and 22 only have smaller contact faces, and the contacting equal-diameter portions 212 and 222 of the two rolls 21 and 22 are aligned with the elongated hole 411 of the paper towel 4 (see FIG. 14). Preferably, the length of the contacting equal-diameter portions 212 and 222 of the two rolls 21 and 22 is smaller than that of the elongated hole 411 of the paper towel 4. Thus, when a rotation speed difference is produced between the first roll set 1 and the second roll set 2, the motor may provide a smaller drive torque to tear the paper towel 4 between the first roll set 1 and the second roll set 2.

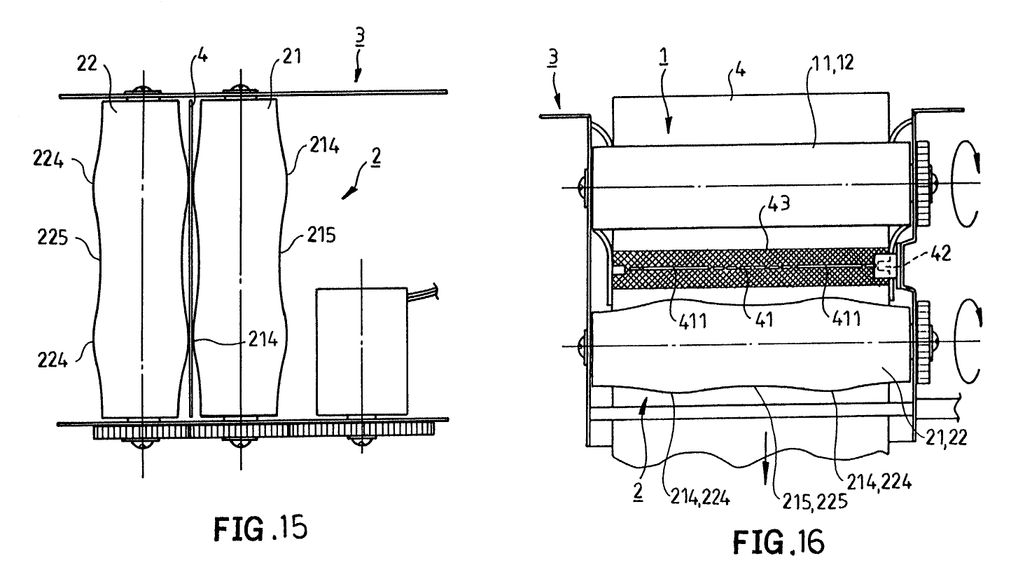

Referring to FIG. 15, the second roll set 2 of a separation device of a paper towel in accordance with a fifth embodiment of the present invention is shown. The second roll set 2 consists of two rolls 21 and 22. Each of the roll faces of the two rolls 21 and 22 may form a non-single line. In the preferred embodiment, each of the roll faces of the two rolls 21 and 22 is formed with a corrugated shape, thereby forming multiple convex portions 214 and 224 and multiple concave portions 215 and 225 between the multiple convex portions 214 and 224. Thus, the roll faces of the two rolls 21 and 22 only have smaller contact faces, and the contacting convex portions 214 and 224 of the two rolls 21 and 22 are aligned with the elongated hole 411 of the paper towel 4 (see FIG. 16). Thus, when a rotation speed difference is produced between the first roll set 1 and the second roll set 2, the motor may provide a smaller drive torque to tear the paper towel 4 between the first roll set 1 and the second roll set 2.

Accordingly, the separation device of a paper towel in accordance with the present invention needs not to provide a cutting blade set, thereby simplifying the construction, and facilitating production and assembly. In addition, the separation device of a paper towel in accordance with the present invention does not have the problem of wear of the cutting blade, thereby facilitating maintenance. Further, the supply length of the paper towel may be set during fabrication. In comparison, in the conventional separation device of a paper towel, the tooth number of the gear and the rotation speed of the motor need to be changed when the supply length of the paper towel needs to be changed. Further, the roll faces of the two rolls of the second roll set only have smaller contact faces, and the contacting faces of the two rolls of the second roll set are aligned with the elongated hole of the paper towel, so that the paper towel between the first roll set and the second roll set may be torn out easily, and the motor for driving the first roll set and the second roll set may provide a smaller drive torque to tear the paper towel between the first roll set and the second roll set, thereby reducing loss of power.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A separation device of a paper towel, comprising: a housing provided with two roll sets each having at least two rolls that may be driven by a power member to rotate relative to each other at an equal speed, so that a continuous paper towel may pass between the rolls of the two roll sets and may be pulled downward, the paper towel provided with sensing marks at a predetermined length, so that when the sensing mark of the paper towel passes through a detection member, the detection member may detect passage of the sensing mark of the paper towel, and may send a signal, so that a rotation speed difference is produced between the rolls of the two roll sets, and the paper towel passing between the rolls of the two roll sets may be torn off.

2. A separation device of a paper towel, comprising:
a housing, having two wall plates and provided with a detection member;
a first roll set, consisting of at least two rolls each having two ends respectively pivoted between the two wall plates, to be driven by a power member to form a relative rotation;
a second roll set, consisting of at least two rolls each having two ends respectively pivoted between the two wall plates, to be driven by a power member to form a relative rotation;
a paper towel, forming a continuous paper roll and provided with sensing marks, the paper towel passed through the rolls of the first roll set and the second roll set respectively, and pulled downward by the rolls of the first roll set and the second roll set at an equal speed;
wherein, when the sensing mark of the paper towel passes through the detection member, the detection member may detect passage of the sensing mark of the paper towel, and may send a signal to stop rotation of the first roll set, or to let a rotation speed of the first roll set be smaller than that of the second roll set, so that the paper towel passing between the first roll set and the second roll set may be torn off.

3. The separation device of a paper towel as claimed in claim 1, wherein each of the two roll sets is provided with a power member to drive the rolls to rotate.

4. The separation device of a paper towel as claimed in claim 2, further comprising a clutch wheel mounted between the two roll sets, wherein the clutch wheel is controlled by a controller to mesh with or detach from drive members provided by the rolls of the two roll sets, so that the drive members may drive one of the two roll sets to rotate, or the two roll sets may be rotated at an equal speed.

5. The separation device of a paper towel as claimed in claim 1, wherein the roll face of the rolls of the two roll sets contacting with each other or almost contacting with each other has a length smaller than that of an elongated hole of the paper towel.

6. The separation device of a paper towel as claimed in claim 2, wherein the roll faces of the multiple rolls provided by one of the two roll sets form a non-single line, and the roll faces of the rolls contact with each other or almost contact with each other.

7. The separation device of a paper towel as claimed in claim 6, wherein the roll faces of the multiple rolls provided by one of the two roll sets forming a non-single line have arcuate convex portions which contact with each other or almost contact with each other.

8. The separation device of a paper towel as claimed in claim 6, wherein the roll faces of the multiple rolls provided by one of the two roll sets forming a non-single line have equal-diameter portions each having a larger diameter, each of the equal-diameter portions has two sides each having an oblique shoulder portion, the equal-diameter portions of the multiple rolls contact with each other or almost contact with each other.

9. The separation device of a paper towel as claimed in claim 6, wherein the roll faces of the multiple rolls provided by one of the two roll sets forming a non-single line form a corrugated shape, thereby forming multiple convex portions and multiple concave portions between the multiple convex portions, and multiple convex portions of the multiple rolls contact with each other or almost contact with each other.

10. The separation device of a paper towel as claimed in claim 6, wherein the paper towel is provided with a sensing mark and a easily detachable line, the easily detachable line is formed with holes of different lengths, and the holes are aligned with the position of the roll faces that contact with each other or almost contact with each other.

11. The separation device of a paper towel as claimed in claim 2, wherein each of the roll sets is provided with a guide board to guide the paper towel to enter between the rolls of the roll sets.

12. The separation device of a paper towel as claimed in claim 2, wherein the housing is provided with a liquid spray tube to wet the paper towel.

13. The separation device of a paper towel as claimed in claim 2, wherein the housing is provided with a guide plate to guide the torn paper towel downward.

14. A paper towel, forming a continuous paper roll, and provided with sensing marks at a predetermined length.

15. The separation device of a paper towel as claimed in claim 14, wherein the sensing mark is formed with a cutout.

16. The separation device of a paper towel as claimed in claim 14, wherein the sensing mark is formed with a cutout, or is formed on the paper towel in a printing or bonding manner.

17. The separation device of a paper towel as claimed in claim 14, wherein the paper towel is provided with a easily detachable line.

18. The separation device of a paper towel as claimed in claim 17, wherein each of the two sides of the easily detachable line is formed with a press portion.

19. The separation device of a paper towel as claimed in claim 17, wherein the easily detachable line is formed by holes of different lengths.
